(19) United States
(12) Patent Application Publication
(10) Pub. No.: US 2023/0000598 A1
(43) Pub. Date: Jan. 5, 2023

(54) ANCHORING DEVICE FOR IMPLANT-SUPPORTED DENTAL PROSTHESES

(71) Applicant: Hader Solutions & Distribution LTD., Dublin 2 (IE)

(72) Inventor: Tanja GROBECKER-KARL, Homburg / Saar (DE)

(21) Appl. No.: 17/782,191

(22) PCT Filed: Nov. 4, 2020
(86) PCT No.: PCT/EP2020/080884

§ 371 Date: Jun. 3, 2022

(30) Foreign Application Priority Data
Dec. 4, 2019 (DE) 10 2019 008 401.2

(51) Int. Cl. A61C 8/00

(52) U.S. Cl. CPC A61C 8/0057; A61C 2201/007

(57) ABSTRACT

The invention relates to an anchoring device (1) for implant-supported removable dental prostheses having a female anchoring part (2); having a male anchoring part (3) connected to the female anchoring part (2); and having a base (4) that comprises a connection geometry arrangement (4A) and an implant thread (4B) for fastening the anchoring device (1) in an implant (6), characterized in that the male anchoring part (3) and the base (4) are interconnected by an elastic connection element (5).

The invention relates to an anchoring device for implant-supported dental prostheses according to the preamble of claim 1.

Dental implants are ankylotically connected to the alveolar bone, which results in a reduced deflectability by a factor of 10 compared to natural teeth with periodontal structures. This difference results in several difficulties or disadvantages:
Inaccuracies in position transfer or in the fabrication of multi-unit dentures cannot be compensated;
Tooth-implant supported fixed dental prostheses are problematic and show poorer survival rates;
the loading situation of the bone is fundamentally different, since the hydraulic damping effect (vasculature) established in the periodontium is missing; and
missing receptors result in a higher threshold for loads compared to the natural tooth.

Anchoring devices known from the prior art show several approaches to solve the aforementioned problems by means of various damping elements. These are in detail:
Progressive loading of implants (increasing occlusal loading to allow adaptation of the implant-bone interface);
Resin for shaping the occlusal complex;
Intramobile cylinder element of IMZ implants;
Cementing implant-supported restorations with variably compensating cement layer; and
Use of soft plastic secondary components as fixation for removable prostheses.

Because these compensatory mechanisms do not have a preferred direction, their effectiveness is questionable and some have disappeared from clinical practice again.

Several fixation types, also known as attachment types, are available for anchoring removable prostheses:
Bar
Ball anchor
Magnet
Locator
Telescope (individually milled cylinder or cone telescope/prefabricated cone telescope).

Single standing anchors (attachments) allow greater flexibility in prosthesis fabrication, as non-optimal implant positions can be compensated. They also allow better cleaning by the patient. Traditionally, at least two implants are required to anchor a prosthesis. If these are not parallel to each other, there is increased wear at the interface of a male anchoring part (male part attachment) and a female anchoring part (female part attachment).

Although prefabricated telescopes are available in the form of cone telescopes, telescopes are predominantly milled individually, which makes them expensive to manufacture. With telescopes on natural teeth, there is a reduction in retention force during the initial wearing phase as the teeth move into the positions predetermined by the telescopes. This does not happen or does not happen to a sufficient extent with implants, which leads to problems in setting a pull-off force that is adequate for the patient and uniform on all telescopes. This phenomenon is also due to inaccuracies in the transfer of implant positions as well as their ankylotic fixation. In vitro experiments carried out in the context of the present invention showed that the pull-off force of two interlocked telescopes was lower when they were fixed on resiliently supported implants compared to situations with rigidly supported implants.

Further investigations and tests carried out in the context of the invention have shown that in the case of rigid attachments (anchoring), in addition to loads due to the deformation of the mandible, the momentum loading of the implants under chewing load on the prosthesis saddles is critical. Here magnets offer advantages as anchoring elements, as they lead to decoupling of implant and prosthesis.

However, due to corrosion processes and low retention force, magnets have not become established. Resilience telescopes, which have a compensating mechanism due to an incorporated free space between the primary and secondary crowns, behave comparably favorably, but are difficult to manufacture. Consequently, a clinical study showed a lower after-care effort with resilience telescopes than with the use of ball anchors. That momentum loads are critical can be deduced from another clinical study in which two implants in the maxilla were used with telescopes to anchor a prosthesis and performed significantly worse compared to the use of natural abutments. In the mandible, due to the better bone quality, the clinical results seem to be better when using two implants with any attachments (anchoring), i.e. the bone seems to be able to tolerate the momentum loads there.

As another known, comparatively new form of therapy for the edentulous mandible a single implant placed centrally in the anterior region, which is only intended to increase the positional stability of the prosthesis, is advocated. However, rocking of the prosthesis over the implant must be avoided. The anchorings or anchoring devices (attachments) described above are also used here. The implant is inserted as far anteriorly as possible in order to have only one direction of movement of the prosthesis, namely dorsal sinking. Eccentric implant positions, such as the otherwise frequently used canine region, are avoided, although anatomical reasons, such as the occurrence of a neurovascular canal in the center of the mandible, make these preferable.

It is therefore the task of the present invention to create an anchoring device for removable, implant-supported dental prostheses according to the preamble of claim 1, which prevents overloading of the implant and the peri-implant bone and compensates for disparallelities.

This task is solved by the features of claim 1.

Advantageously, by providing an elastic connection element between the male anchoring part and the connection to the implant, an elastic connection can be created between these two components. The arrangement is chosen in such a way that a vertical change in position between the implant and anchoring or prosthesis is not possible, or at least hardly possible, while lateral changes in position and changes in angle are, however, easily possible.

An in vitro study carried out in the context of the present invention has shown that the loading situation of the peri-implant bone is more favorable when using one or two implants in the mandible with such elastic anchoring elements for prosthesis retention than with anchorings that do not have an elastic connection element between male part and base.

Particularly with the previously explained use of one or two implants for prosthesis retention, prosthesis displacement occurs under chewing load. A further advantage of the present invention consists in an adjustable restoring force of the anchoring device, which restoring force is in particular adjustable via the diameter of the connection element. When the prosthesis is unloaded, this leads to a return to its bearing congruent rest position. The connection element can also compensate for greater abutment disparallelism than is possible with known anchoring devices.

The arrangement of the elastic connection element can be done in the following way:
between the base, in particular its implant connection geometry, and the male anchoring part, wherein the connection element can also be designed as a separately available product;
the entire anchoring device may be of elastic construction, in particular of a shape memory alloy;
the connection element can form the male anchoring part and is connected to the implant connection geometry of the base.

The dependent claims deal with advantageous further embodiments of the invention.

In particular, the connection element may be wire-shaped and, in a particularly preferred embodiment, the material of the connection element is a shape memory alloy. A particularly preferred material for the shape memory alloy is nickel-titanium (NiTi).

In another particularly preferred embodiment, it is possible to adjust the restoring force of the connection element using different diameter sizes of the connection element.

Further details, advantages and features of the present invention will be apparent from the following description of embodiments based on the drawing. Shown in:

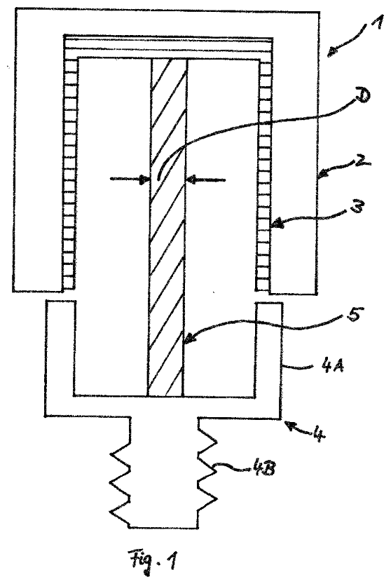

FIG. 1 is a schematic, highly simplified schematic illustration of a possible embodiment of an anchoring device according to the invention,

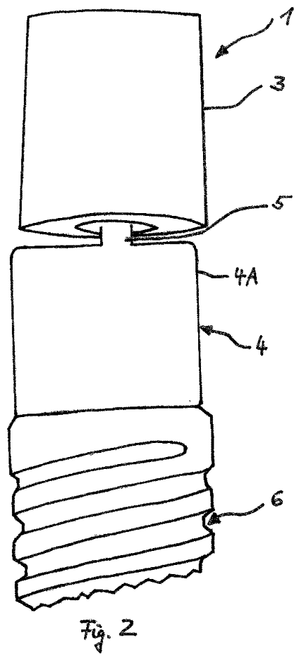

FIG. 2 is an embodiment of the anchoring device according to the invention without a female anchoring part arranged on a male anchoring part, and

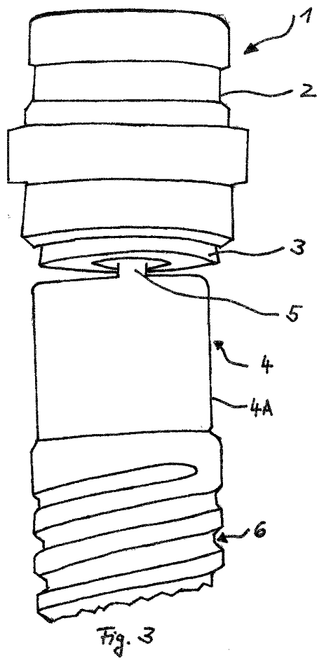

FIG. 3 is an illustration corresponding to FIG. 2 with mounted female anchoring part.

The general structure of an anchoring device 1 according to the invention, which is also referred to as an attachment system in dental terminology, can be seen from the schematic illustration in FIG. 1.

The anchoring device 1 is suitable for implant-supported, removable dental prostheses and for this purpose has a female anchoring part 2, which is arranged on the outside of a male anchoring part 3 and is plugged on, so that the female anchoring part 2 can advantageously be detached from the support of the dental prosthesis.

Furthermore, the anchoring device 1 has a base 4, which is provided with a connection geometry arrangement 4A, which is followed by an implant thread 4B, which is preferably integrally connected to the connection geometry arrangement 4A. Thus, the implant thread 4B serves to fix the anchoring device 1 in the implant.

According to the invention, the anchoring device 1 further comprises an elastic connection element 5, which is in particular wire-shaped with a diameter D and which elastically connects the male anchoring part 3 to the base 4, in particular to the connection geometry arrangement 4A of the base 4.

FIG. 2 shows a concretely realized anchoring device 1 with the components previously explained with reference to FIG. 1, so that in FIG. 2 all components corresponding to those of the schematic illustration of FIG. 1 are marked with the same reference numbers.

In particular, it is clear from FIG. 2 that the elastic connection element 5, which may be formed in particular from a shape memory alloy, for example nickel-titanium, has a diameter that is significantly smaller than the diameters of the male part 3 and the base 4, in particular the connection geometry arrangement 4A.

Furthermore, FIG. 2 shows an implant 6 connected to implant thread 4B (not visible in FIG. 2).

FIG. 3 illustrates the anchoring device 1 according to FIG. 2, with the female anchoring part 2 arranged on the male anchoring part 3.

In the embodiment according to FIGS. 1 and 2, the female anchoring part 2 and the male anchoring part 3 are each formed as a cone telescope, while the female anchoring part 2 of the schematic illustration of FIG. 1 is formed as a cylinder secondary telescope, which also applies to the male anchoring part 3 of the embodiment according to FIG. 1.

In addition to the foregoing written disclosure, explicit reference is hereby made to the graphic illustration in FIGS. 1 to 3 to supplement the disclosure.

### List of Reference Signs

1 Anchoring device
2 Female anchoring part
3 Male anchoring part
4 Base
4A Connection geometry arrangement
4B Implant thread/thread for fastening the anchoring device (attachment) in the implant
5 Connection element
Implant
D Diameter

1. An anchoring device (1) for an implant-supported removable dental prostheses
having a female anchoring part (2);
having a male anchoring part (3) connected to the female anchoring part (2); and
having a base (4) that comprises a connection geometry arrangement (4A) and an implant thread (4B) for fastening the anchoring device (1) in an implant (6), characterized in that
the male anchoring part (3) is formed by an elastic connection element (5) allowing lateral changes in position and changes in angle between the female anchoring part (2) and the base (4) and is connected to the connection geometry arrangement (4A) of the base (4) or the male anchoring part (3) and the base (4) are interconnected by an elastic connection element (5) allowing lateral changes in position and changes in angle between the female anchoring part (2) and the base (4) so that an elastic connection is created between the male anchoring part (3) and the base (4), wherein the connection element (5) is wire-shaped.

2. (canceled)

3. The anchoring device according to claim 1, characterized in that the material of the connection element (5) is a shape memory alloy.

4. The anchoring device according to claim 3, characterized in that the shape memory alloy is nickel-titanium.

5. The anchoring device according to claim 1, characterized in that the material of the female anchoring part (2), the male anchoring part (3), the base (4) and the connection element (5) is a shape memory alloy.

6. The anchoring device according to claim 5, characterized in that the shape memory alloy is nickel-titanium.

7. (canceled)

8. The anchoring device according to claim 1, characterized in that the connection element (5) is formed as a separately tradable product.

9. The anchoring device according to claim 1, characterized in that the connection element (5) has a circular cross-section.

10. The anchoring device according to claim 9, characterized in that a restoring force of the connection element (5) can be adjusted via the diameter (D) of the connection element (5).
